(19) United States
(12) Patent Application Publication
(10) Pub. No.: US 2026/0299673 A1
(43) Pub. Date: Oct. 1, 2026

(54) USE-CASE-DRIVEN POWER OPTIMIZATION FOR INTEGRATED CIRCUITS WITH PROCESS CORNER AWARENESS

(71) Applicant: QUALCOMM Incorporated, San Diego, CA (US)

(72) Inventors: Shengqi YANG, Carlsbad, CA (US); Wenping WANG, Carlsbad, CA (US); Shih-Hsin Jason HU, San Diego, CA (US)

(21) Appl. No.: 19/090,255

(22) Filed: Mar. 25, 2025

(51) Int. Cl. G06F 1/3296

(52) U.S. Cl. CPC G06F 1/3296

(57) ABSTRACT

A method for dynamically controlling power consumption of a portable computing device is disclosed. The portable computing device includes a plurality of functional blocks. The method includes receiving a use case, identifying critical functional blocks from the plurality of functional blocks based on the use case, taking votes from the identified critical functional blocks, and adjusting the supply voltage level based on the votes. A vote indicates an adjustment to the supply voltage level.

### FIELD OF TECHNOLOGY

The technology discussed below relates to integrated circuits and, more particularly, to systems and methods for power optimization that account for use cases as well as silicon performance variations across different process corners.

### BACKGROUND

Computing devices are ubiquitous. Some computing devices are portable such as smartphones, tablets and laptop computers. In addition to the primary function of these devices, many include elements that support peripheral functions. For example, a cellular telephone may include the primary function of enabling and supporting cellular telephone calls and the peripheral functions of a still camera, a video camera, a music player, global positioning system (GPS) navigation, web browsing, sending and receiving emails, sending and receiving text messages, push-to-talk capabilities, etc.

Some conventional designs for handheld portable computing devices include multiple processors and/or processors with multiple cores to support the various primary and peripheral functions desired for a particular computing device. Such designs often further integrate analog, digital and radio-frequency circuits or functions on a single substrate and are commonly referred to as a System-on-Chip (SoC). These different circuits and functions will often require different operating frequencies and voltage levels and are at times segregated based on common input requirements. When such segregation is based on input voltage the different circuits may share a common power source.

The desire to conserve energy stored in a battery that powers such portable devices has led to the implementation of dynamic power management techniques. A dynamic power management technique may use sensors to measure performance metrics of circuit blocks, such as operating speed across process, voltage, and temperature variations, also known as PVT corners. The SoC may adjust the operating parameters of the circuit blocks in respective integrated circuits, such as operating voltages or operating frequencies, based on the sensor outputs. In this manner, the SoC may minimize the operating parameters to meet workload requirements and reduce power consumption.

One design challenge is achieving further fine-tuned power optimization based on specific use cases.

### SUMMARY

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In accordance with an aspect of the disclosure, a method for dynamically controlling power consumption of a portable computing device, the portable computing device including a plurality of functional blocks, is provided that includes: receiving a use case; identifying critical functional blocks from the plurality of functional blocks based on the use case; taking votes from the identified critical functional blocks, wherein a vote indicates an adjustment to a supply voltage level; and adjusting the supply voltage level based on the votes.

In accordance with another aspect of the disclosure, a system for dynamically controlling a power domain in a portable computing device is provided that includes: a plurality of functional blocks sharing the power domain; a plurality of performance sensors associated with the functional blocks; and a controller drives the performance sensors, wherein the controller is configured to: receive information of a use case presently executed by the portable computing device; identify from the functional blocks critical functional blocks associated with the use case; take votes by measuring the performance sensors associated with the critical functional blocks; and determine an adjusted supply voltage for the power domain.

In accordance with yet another aspect of the disclosure, an apparatus is provided that includes: a plurality of means for sensing performance of circuitry in an integrated circuit, wherein at least one of the plurality of means for sensing performance is located in each of a plurality of functional blocks in the integrated circuit, and wherein the plurality of means for sensing performance include sensors for heterogeneous circuits that have different relationships between supply voltage and circuit speed; and a means for controlling voltages of the plurality of functional blocks configured to: collect a list of the plurality of functional blocks deemed critical for a use case; assign the functional blocks in the list to a voting pool; collect votes from the voting pool; and determine a target voltage level for the plurality of functional blocks based on the collected votes.

Other aspects, features, and implementations of the present disclosure will become apparent to those of ordinary skill in the art, upon reviewing the following description of specific, exemplary implementations of the present disclosure in conjunction with the accompanying figures. While features of the present disclosure may be discussed relative to certain implementations and figures below, all implementations of the present disclosure can include one or more of the advantageous features discussed herein. In other words, while one or more implementations may be discussed as having certain advantageous features, one or more of such features may also be used in accordance with the various implementations of the disclosure discussed herein. In similar fashion, while exemplary implementations may be discussed below as device, system, or method implementations it should be understood that such exemplary implementations can be implemented in various devices, systems, and methods.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various implementations and to explain various principles and advantages in accordance with the present disclosure.

FIG. 1 illustrates a schematic diagram of an example portable computing device, in accordance with aspects of the present disclosure.

FIG. 2 illustrates a plot of electrical potential and frequency as applied to a test integrated circuit in separate semiconductors, in accordance with aspects of the present disclosure.

FIG. 3 illustrates an electronic system with a power reduction technique for multiple power domains, in accordance with aspects of the present disclosure.

FIG. 4 illustrates an electronic system with a power reduction technique for shared power domains, in accordance with aspects of the present disclosure.

FIG. 5 illustrates a functional block diagram of aspects of a performance sensor, in accordance with aspects of the present disclosure.

FIG. 6 illustrates an electronic system with a use-case driven power reduction technique, in accordance with aspects of the present disclosure.

FIG. 7 illustrates a voting process to reduce supply voltages in multiple power domains based on a use-case driven power reduction technique, in accordance with aspects of the present disclosure.

FIG. 8 illustrates a multimedia platform with a use-case driven power reduction technique under one exemplary use case, in accordance with aspects of the present disclosure.

FIG. 9 illustrates a multimedia platform with a use-case driven power reduction technique under another exemplary use case, in accordance with aspects of the present disclosure.

FIG. 10 illustrates a module inside a multimedia platform with a use-case driven power reduction technique under one exemplary use case, in accordance with aspects of the present disclosure.

FIG. 11 illustrates a module inside a multimedia platform with a use-case driven power reduction technique under another exemplary use case, in accordance with aspects of the present disclosure.

FIG. 12 is a flowchart illustrating an exemplary method for power reduction based on use cases, in accordance with aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

In this description, the term “exemplary” is used herein to mean “serving as an example, instance, or illustration.” Any aspect described herein as “exemplary” is not necessarily to be construed as preferred or advantageous over other aspects.

The term “application” may also include files having executable content, such as: object code, scripts, byte code, markup language files, and patches. In addition, an “application” referred to herein, may also include files that are not executable in nature, such as documents that may need to be opened or other data files that need to be accessed.

The term “content” may also include files having executable content, such as: object code, scripts, byte code, markup language files, and patches. In addition, “content” referred to herein, may also include files that are not executable in nature, such as documents that may need to be opened or other data files or data values that need to be accessed.

The terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer-readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

The term “portable computing device” or “PCD” is intended to refer to any device operating on a limited-capacity rechargeable power source, such as a battery or capacitor. Technological advances in rechargeable batteries and in wireless communication (3G, 4G, 5G, etc.) have enabled PCDs with multiple capabilities. Examples of such PCDs include cellular telephones, satellite telephones, pagers, personal digital assistants (PDAs), smartphones, navigation devices, smartbooks or e -readers, media players, and laptop or tablet computers with wireless connectivity, among others.

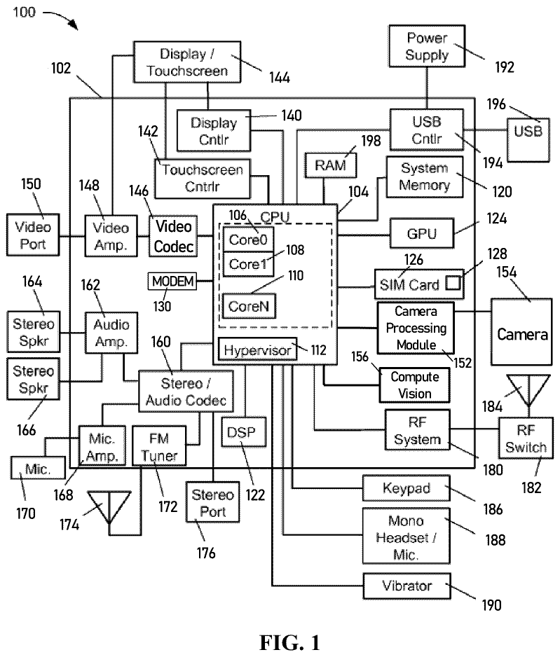

Referring to FIG. 1, an exemplary portable computing device (PCD) 100 is shown, which includes an on-chip system 102 that integrates various subsystems. In some arrangements, the on-chip system 102 is an SoC design. A multicore CPU 104 resides within the on-chip system 102 and may include a zero^{th} core 106, a 1^{st} core 108, and an N^{th} core 110. These cores can be managed under a power domain that operates autonomously or under a hypervisor 112. The hypervisor 112 can execute power management algorithms (stored in system memory 120) and record status information from select peripheral elements, such as the digital signal processor (DSP) 122 and the graphical processor unit (GPU) 124, to reduce overall power consumption on the PCD 100 in real time. The DSP 122 may be used for specialized signal-processing operations, and the GPU 124 may be used for providing graphics processing capabilities for rendering user interfaces or other visually intensive tasks.

The system memory 120, which holds instructions for the hypervisor 112 and other software, may be coupled directly to the multicore CPU 104. Other than the system memory 120, the on-chip system 102 also includes a random access memory (RAM) 198, which is a volatile memory device coupled to the multicore CPU 210. The RAM 198 temporarily stores instructions and data for rapid access during system operation.

In some arrangements, a subscriber identity module (SIM) card module 126 for hosting a SIM car 128 is also coupled to the CPU 104 for cellular network authentication. A modem 130, which may handle various communication protocols, may similarly be coupled to the multicore CPU 104. In some instances, the modem 130 may include a network card for accessing local area networks (LANs), personal area networks (PANs), or other data networks. This network card may be a Bluetooth card, Wi-Fi card, or any other known network interface and can be integrated into a single chip or separate from the on-chip system 102.

The PCD 100 may include a display controller 140 and a touchscreen controller 142 interfacing with a display/touchscreen 144. The display controller 140 drives visual content, while the touchscreen controller 142 processes user touch inputs. A video CODEC 146 (capable of encoding/decoding video streams) is also coupled to the multicore CPU 104. Video signals pass through a video amplifier 148 to the display/touchscreen 144, with a video port 150 provided for external video outputs or signals.

In FIG. 1, a camera processing module 152, which may include image signal processor (ISP), thin front end (TFE), and/or image processing engine (IPE), is coupled to the multicore CPU 104. A digital camera 154, which may be a charge-coupled device (CCD) or a complementary metal-oxide semiconductor (CMOS) camera, feeds raw image data to the camera processing module 152. A compute vision module 156 may also be coupled to the multicore CPU 104 to perform advanced image processing functions, such as object recognition, depth sensing, or scene interpretation.

A stereo/audio CODEC 160 is coupled to the multicore CPU 104 for audio input and output processing. An audio amplifier 162 drives a first stereo speaker 164 and a second stereo speaker 166. A microphone amplifier 168 is likewise connected to the stereo/audio CODEC 160 and in turn to a microphone 170 for voice capture. In some aspects, a frequency modulation (FM) tuner 172 is also coupled to the stereo/audio CODEC 160, and an FM antenna 174 provides reception for radio broadcasts. A stereo port 176 may be included for external audio connections (e.g., headphones or external speakers).

An RF system (or RF transceiver) 180 is coupled to the multicore CPU 104 to handle wireless communication. The RF switch 182 and RF antenna 184 connect externally for signal transmission/reception. The RF system 180 may support one or more wireless protocols, including GSM, CDMA, W-CDMA, TD-SCDMA, LTE (and LTE variations), and future wireless protocols. In the illustration, the RF system 180 is integrated into the on-chip system 102, although it may also be external or partially external in alternative configurations.

Various user interface and mechanical components shown in FIG. 1 reside outside the on-chip system 102. These include the keypad 186 for input, a mono headset with microphone 188, and a vibrator 190 for tactile alerts. A power supply 192, such as a direct current (DC) battery or an AC-derived DC source, provides power to the PCD 100 and connects (in some configurations) via the USB controller 194. Additionally, a USB port 196 is coupled to the USB controller 194 for data/power connections.

Although FIG. 1 depicts a single instance of a multicore CPU 104, one or more similarly configured CPUs may be included to support the various peripheral devices and functions in PCD 100. Alternatively, one or more single-core processors could be deployed. Any of the methods described herein may be enabled by data and processor instructions stored in the system memory 120 (or other non -transitory storage, such as an EEPROM), and executed by the multicore CPU 104. These instructions may include logic for power optimization, use-case information, responsiveness data, and configuration parameters for executing one or more of the method steps described herein.

Reducing integrated circuit power consumption in an SoC design, such as the SoC 102 illustrated in FIG. 1, has become increasingly important, particularly in battery-powered devices. Reducing the supply voltage can reduce power consumption. The minimum supply voltage needed to operate the integrated circuits can vary based on various conditions such as manufacturing variations, circuit characteristics, temperature, and operational modes of various modules in the integrated circuit. Dynamic power management can be used to control the supply voltage based on sensed performance measures of the integrated circuits.

A dynamic power management technique applied in an SoC design may scale input voltage as a function of measured circuit performance to compensate for semiconductor manufacturing process variation to achieve a desired target performance. When the multiple cores or functional blocks in a single power domain have different responses to the same input voltage, the core or functional block that responds the slowest dictates the input voltage that is required. Accordingly, the input voltage necessary to achieve the desired performance is applied to the power domain.

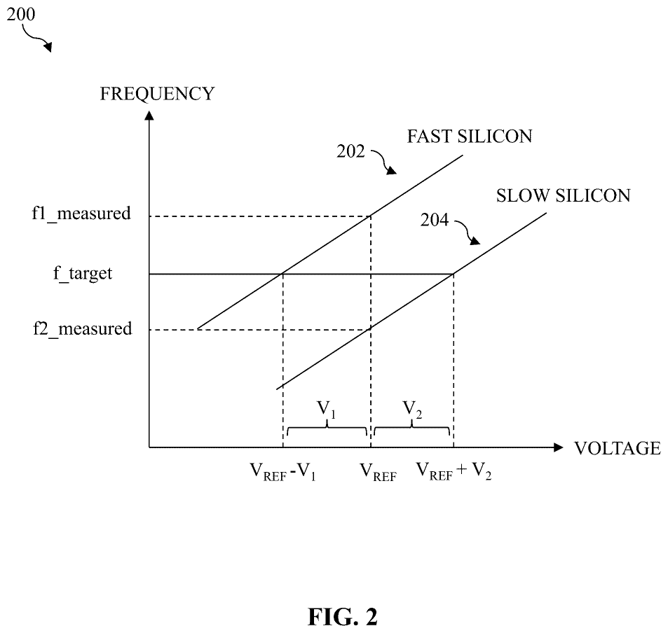

FIG. 2 includes a plot 200 of voltage and frequency as applied to a test circuit integrated in separate semiconductors. Input voltage is shown along the horizontal axis while the frequency response of the test circuit is shown along the vertical axis. The responsiveness of a test circuit in a first semiconductor die is depicted by line 202, while the responsiveness of a respective test circuit in the second semiconductor die is shown by line 204. The first test circuit in the first semiconductor die responds in less time and at a lower input voltage than an identical test circuit in the second semiconductor die. As shown in the plot, when a reference voltage V_{REF} is applied, the fast silicon can achieve a frequency (e.g., f1_measured) that exceeds a target frequency, f_target. As further shown in the plot, a supply voltage V_{REF}−V₁ applied to the test circuit of the first semiconductor die enables the test circuit to achieve the target operating frequency. Conversely, when V_{REF} is applied to the second semiconductor die, the test circuit achieves a frequency f2_measured that is lower than the target frequency. A supply voltage V_{REF}+V₂ must be applied to the second semiconductor die to enable the test circuit to achieve the target frequency. Under these circumstances, the first semiconductor die is often referred to as having “fast” silicon, while the second semiconductor die is often referred to as having “slow” silicon. As further illustrated in FIG. 1, the variation between the respective responsiveness of the first and second semiconductor dies shows that in order to achieve a desired or target frequency across both dies, the input voltage required for the slow silicon to achieve the target frequency is required. Thus, the fast silicon will be operated with a voltage margin that is the equivalent of the sum of V₁ and V₂.

The switching power dissipated by a semiconductor using static CMOS gates is C×V²×f, where C is the capacitance being switched per clock cycle, V is the supply voltage, and f is the switching frequency, so this part of the power consumption decreases quadratically with changes in supply voltage. The formula is not exact however, as many modern digital signal processors (DSPs) and multiple core processors are not implemented with only CMOS, but also use special memory circuits, dynamic logic such as domino logic, etc. Moreover, there is also a static leakage current, which has become more and more accentuated as semiconductor device feature sizes become smaller and threshold levels decrease.

Accordingly, dynamic voltage scaling may be applied in strategies to manage switching power consumption in battery powered devices. Low voltage modes are used in conjunction with lowered clock frequencies to minimize power consumption associated with components such as multiple core processors and DSPs. When a desired performance demands significant computational power, the voltage and frequency are increased.

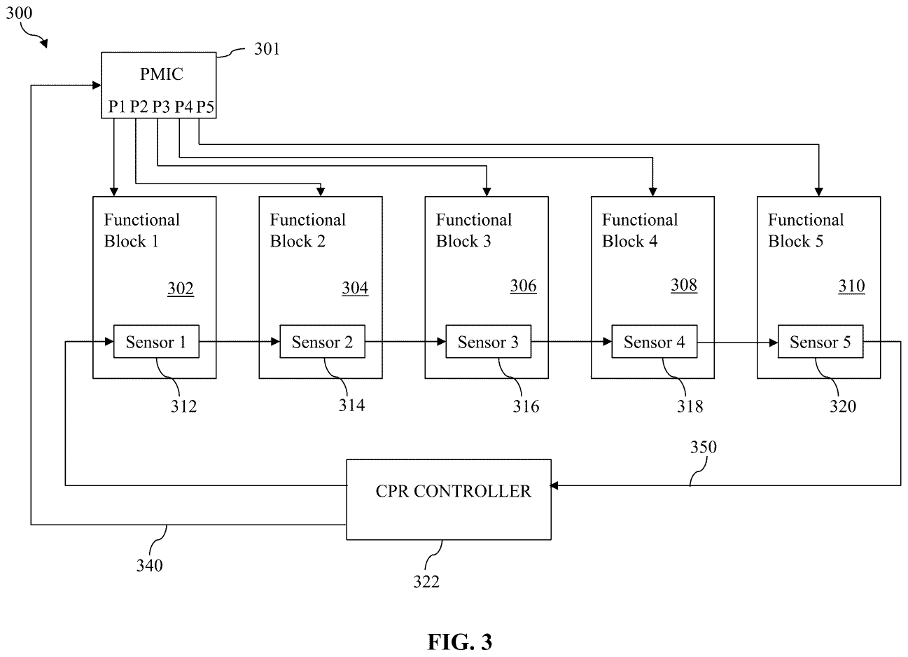

FIG. 3 is a schematic diagram of a system 300, such as an SoC, with multi-domain heterogeneous process-voltage-temperature tracking according to a presently disclosed arrangement. Multi-domain refers to the system using multiple power domains that can have independent voltage levels. Heterogeneous refers to the system including disparate types of circuits. Process-voltage-temperature tracking refers to the system adjusting parameters, such as supply voltages, to track changes in process, voltage, and temperature (which are major influences on circuit performance) or other conditions. The system may be implemented using one or multiple integrated circuits. The system may be, for example, used in a mobile phone.

A power management integrated circuit (PMIC) 301 supplies one or more voltages to the other modules in the system 300. The PMIC 301 may include switching voltage regulators and low-dropout regulators. The PMIC 301 may be a separate integrated circuit. The voltages supplied by the PMIC 301 are also controlled by the chip power reduction (CPR) controller 322. Modules of the systems may have one voltage supply, multiple voltages supplies, or multiple modules may operate with a common voltage supply. Additionally, a module may include a sub-domain that uses a supply voltage that is regulated from another supply voltage. For example, the sub-domain voltage may be regulated down from domain voltage using a low dropout (LDO) regulator or the sub-domain voltage may be switched off to save power from circuits in the sub-domain.

In the illustrative arrangement, the PMIC 301 provides multiple supply voltages, labeled as P1, P2, P3, P4, and P5, to a set of functional blocks 302, 304, 306, 308, and 310, respectively. Since each supply voltage is independently adjustable, P1, P2, P3, P4, P5 also represent multiple power domains. Each of the functional blocks 302-310 separately represents at least one processing resource, such as CPU 104, GPU 124, modem 130, video codec 146, camera processing module 152. In some other arrangements, each of the functional blocks 302-310 separately represents an integrated circuit chip. It should be understood that the number of functional blocks and corresponding power domains illustrated in this example is merely illustrative and not limiting. Any number of functional blocks and power domains may be implemented based on design requirements, and additional, fewer, or alternative functional blocks and power domains may be used without departing from the scope of the present disclosure.

Each of the functional blocks 302-310 includes one or more performance sensors (or process-voltage-temperature (PVT) sensors), such as the performance sensors 312-320. Although FIG. 3 illustrates each functional block includes one performance sensors, an integrated circuit implementation may have tens of performance sensors in each functional block and many hundreds of performance sensors in the whole SoC. Each of the performance sensors includes circuitry to measure circuit speed. For example, the performance sensors may count oscillations of ring oscillators. The performance sensors measure performance characteristics of circuitry in the sensor. Although the performance of circuitry in an integrated circuit may vary with location, temperature, voltage drop, and other parameters, performance measured by a performance sensor can be used to estimate performance of similar circuitry near the performance sensor. The performance sensors are heterogeneous, that is, they provide measurements for different types of circuits (those with different relationships between circuit speed and supply voltage). For example, the performance sensor 312 in the functional block 302 may provide measurements for circuits built using high-speed transistors on “fast” silicon; the performance sensor 314 in the functional block 304 may provide measurements for circuits built using high-speed transistors on “normal” silicon; and the performance sensor 316 in the functional block 306 may provide measurements for circuits built using low-leakage transistors on “slow” silicon, etc.

The CPR controller 322 generally operates to reduce power in the electronic system. The CPR controller 322 provides a control signal via connection 340 to the PMIC 301. The control signal determines the supply voltages generated by the PMIC 301 based on performance measurements from the performance sensors in the corresponding functional blocks. The performance sensors are connected in a scan chain (or referred to as sensor chain) 350 to the CPR controller 322. The scan chain 350 forms a loop of performance sensors with a signal path (e.g., a signal bus) that starts from the CPR controller 322 and ends at the CPR controller 322. The scan chain 350 may also be referred to as a sensor loop. In a circuit layout, the performance sensors may be chained in a zigzag pattern. Measurements from performance sensors that are spread about the SoC are collected and processed by the CPR controller 322 to determine voltage levels for each of the power domains.

The CPR controller 322 can determine the supply voltages so that they equal or only slightly exceed (e.g., 10 mV) the minimum voltages needed for a selected operating frequency. For example, the functional block 302 may require an input voltage of V_{REF}+V₂ (as in FIG. 2) to achieve the desired responsiveness corresponding to f_target, the functional block 304 may require an input voltage of V_{REF}−V₁ (as in FIG. 2) to achieve the desired responsiveness corresponding to f_target, and whereas the functional blocks 306-310 may each individually require a different input voltage. Since the CPR controller 322 may communicate with the PMIC 301 to raise or lower any of the supply voltages P1 through P5 individually, each of the functional blocks 302-310 may receive a supply voltage equal to only slightly exceed the minimum voltage desired for f_target.

An advantage of the system 300 is that the power consumption of each functional block may be individually optimized, as each functional block effectively operates within its own power domain, allowing for separate optimization. However, this comes at the cost of increased complexity in the PMIC design, as well as higher standby power consumption from the PMIC itself due to a large number of voltage regulators needed in the PMIC.

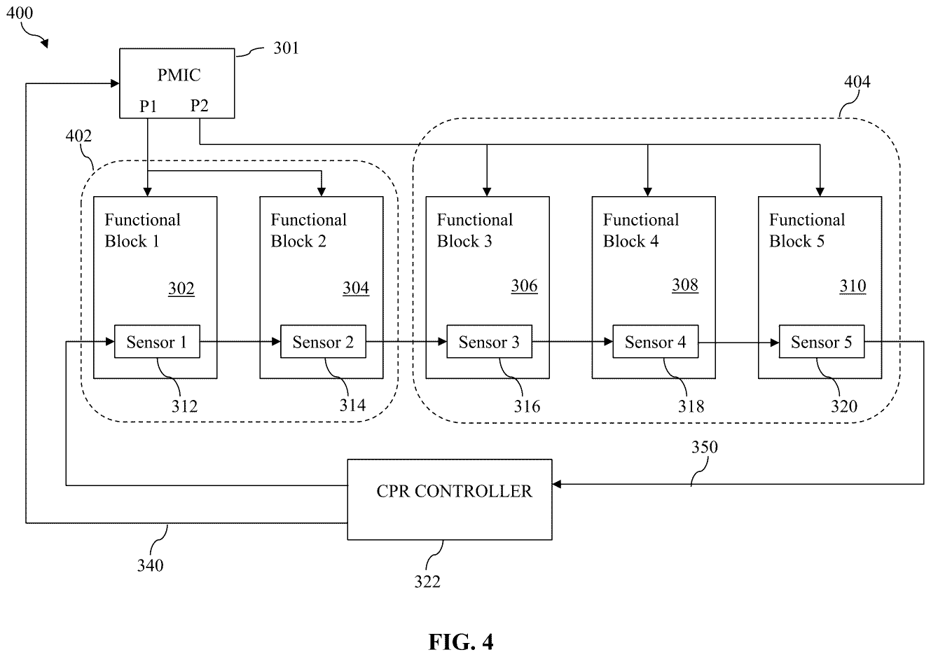

FIG. 4 is a schematic diagram of a system 400, which differs from the system 300 with one or more shared power domains. A shared power domain refers to a power domain in which the input voltage is distributed to multiple functional blocks. In the illustrative arrangement, the functional blocks 302 and 304 are within the shared power domain 402, which receives the supply voltage P1 from the PMIC 301; the functional blocks 306-310 are within the shared power domain 404, which receives the supply voltage P2 from the PMIC 301. It should be understood that the number of functional blocks in one shared power domain and the number of shared power domains illustrated in this example are merely illustrative and not limiting. Any number of functional blocks in one shared power domain and any number of shared power domains may be implemented based on design requirements, and additional, fewer, or alternative functional blocks and shared power domains may be used without departing from the scope of the present disclosure.

The CPR controller 322 provides a control signal via connection 340 to the PMIC 301. Measurements from performance sensors that are spread about the SoC are collected and processed by the CPR controller 322 to determine voltage levels P1 and P2 for each of the shared power domains. Taking the functional blocks inside the shared power domain 402 as an example, the functional block 304 may require an input voltage of V_{REF}+V₂ (as in FIG. 2) to achieve the desired responsiveness corresponding to f_target, and the functional block 302 may require an input voltage of V_{REF}−V₁ (as in FIG. 2) to achieve the desired responsiveness corresponding to f_target. The higher voltage V_{REF}+V₂ dictates the minimum supply voltage the CPR controller 322 determines for P1 so that each functional block in the shared power domain 402 can support the desired target frequency.

An advantage of the system 400 is that the PMIC design can be simplified, and the standby power consumption from the PMIC itself can be reduced due to the smaller number of voltage regulators required. However, this comes at a cost when, at a later time, the system may no longer require the computing resources of each functional block, yet the shared power domain would continue to supply a higher voltage (e.g., V_{REF}+V₂) than necessary for those implemented in “fast” silicon.

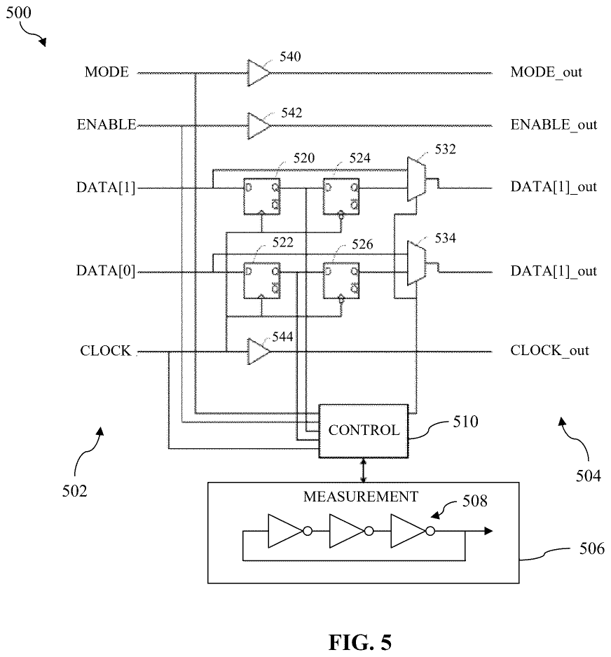

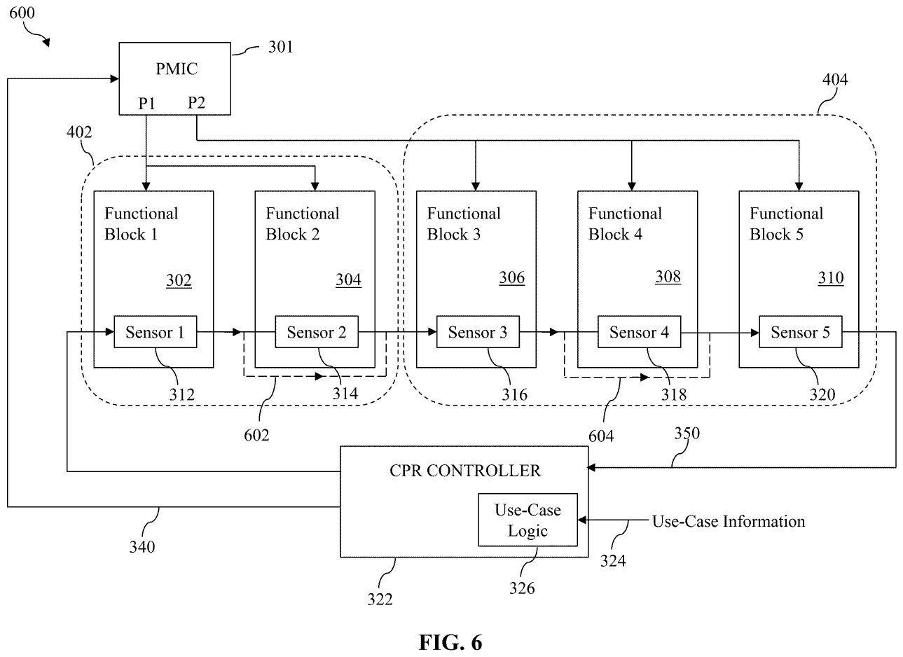

FIG. 5 is a functional block diagram of aspects of a performance sensor 500 according to a presently disclosed arrangement. Circuitry in the performance sensor 500, among other circuitry, may perform the bypass of an individual performance sensor or the bypass of a group of performance sensors in a functional block. The performance sensor 500 may be used to implement the performance sensors in the SoCs illustrated in FIGS. 6 and 8-11, as discussed in further detail below.

The performance sensor 500 receives signals from a prior performance sensor on the scan chain (or a CPR controller if it is the first performance sensor in the scan chain) on an input interface 502 and supplies signals to a subsequent performance sensor on the scan chain (or a CPR controller module if it is the last performance sensor in the scan chain) on an output interface 504. In the illustrated arrangements, each interface includes a mode signal, an enable signal, a clock signal, and a multi-bit data signal. FIG. 5 illustrates a two-bit data signal as a non-limiting example, while a data signal with more or fewer bits may also be implemented.

The performance sensor 500 includes a measurement module 506 with one or more circuits for measuring circuit performance. For example, it may operate a ring oscillator 508 (or a series of an odd number of NOT gates) to generate outputs whose frequencies indicate circuit performance. By measuring the speed or latency of the ring oscillator 508, the CPR controller can determine voltage threshold of the manufactured transistors and assess process variations in the circuit.

In some arrangements, the CPR controller dynamically adjusts the functional block's supply voltage based on the measured latency from the ring oscillator 508. Specifically, the CPR controller compares the actual latency (or frequency) of the ring oscillator to a target performance metric. If the measured latency is longer (i.e., the ring oscillator runs slower) than the target latency, the CPR controller increases the supply voltage to speed up the transistors in the ring oscillator 508 (as well as those transistors in the functional block) and measures the latency again, until meeting the desired latency level. Conversely, if the measured latency is shorter (meaning the ring oscillator is running faster than necessary), the CPR controller lowers the supply voltage to slow down the transistors in the ring oscillator 508 (as well as those transistors in the functional block) measures the latency again, until meeting the desired latency level. This tuning can be repeated periodically so that each corner or domain receives just enough voltage for reliable operation, resulting in improved power efficiency without compromising the required speed or timing margins.

The performance sensor 500 includes a control module 510 that provide control logic for the performance sensor. The control module 510 may include counters to count oscillations of the outputs from the measurement module 506. The counters can count for a known time period to measure frequencies of the ring oscillator 508 in the measurement module 506. The control module 510 also decodes signals received on the input interface 502. The control module 510 can, for example, control modes (e.g., idle, measuring, shifting out results, or bypassed) based on the values of the mode and enable signals. The control module 510 also controls the signals on the output interface 504, for example, to supply measurement results.

The interface signals may use source-synchronous timing to simplify meeting timing requirements. Input data signals are latched into flip-flops 520 and 522 on the rising edges of the clock signal, while output data signals transition on the falling edges by being latched into flip-flops 524 and 526. As a result, the setup and hold times of the data signals relative to the clock signal are approximately half of the clock period. When the performance sensor is bypassed, multiplexers 532 and 534 select the data input signals to directly drive the data output signals. Buffers 540, 542, and 544 receive the mode, enable, and clock signals from the input interface 502 and drive the corresponding signals on the output interface 504. These buffers help maintain the timing relationship between the interface signals across the chain of performance sensors.

Portions of the performance sensor 500 may operate in different supply domains. For example, the measurement module 506 can be connected to the supply voltage of the functional block where the performance sensor is located, while other portions can operate on a common supply voltage shared by all performance sensors. This ensures that when the functional block enters a low-power or standby state, the sensor chain's operation remains unaffected. Additionally, the performance sensor 500 can function independently without direct connections to the functional block.

FIG. 6 is a schematic diagram of a system 600, such as an SoC, which integrates multi-domain heterogeneous PVT tracking while also accounting for use cases in accordance with the present disclosure. In the illustrated arrangement, functional blocks 302 and 304 reside in a shared power domain 402, which receives the supply voltage P1 from the PMIC 301, whereas functional blocks 306-310 reside in another shared power domain 404, which receives the supply voltage P2 from the PMIC 301. The CPR controller 322 provides a control signal to the PMIC 301 via connection 340. Measurements from performance sensors 312-320, which are distributed throughout the SoC, are collected and processed by the CPR controller 322 to determine the appropriate voltage levels P1 and P2 for each shared power domain. The performance sensors 312-320 in system 600 may adopt the design of the performance sensor 500 shown in FIG. 5, which permits one or all sensors in a functional block to be bypassed. It should be understood that the numbers of performance sensors in each functional block, the numbers of functional blocks in each shared power domain, and the numbers of shared power domains shown here are merely illustrative and not limiting. Any suitable combination or quantity of performance sensors, functional blocks, and shared power domains may be used based on design requirements, and more, fewer, or alternative elements may be implemented without departing from the scope of the present disclosure.

The system 600 differs from the system 400 in that the scan chain 350 can be configured in response to use-case information provided via a connection 324 from a source external to the CPR controller 322. Consequently, the control signal from the CPR controller 322 to the PMIC 301 via connection 340 is also responsive to the use-case information.

The CPR controller 322 includes use-case logic 326, which configures the scan chain 350 and consequently the control signal in a manner that optimizes supply voltages to the shared power domains. By executing logic circuits and/or instructions in response to use-case information received via connection 324, the use-case logic 326 initiates or directs adjustments to the scan chain 350. These adjustments in turn influence the control signal that the CPR controller 322 sends to the PMIC 301.

The use-case information includes a listing of functional blocks that are considered critical (or actively operating) under a given use case. Functional blocks not on that list are deemed non-critical (or may be in a low-power or standby state). As a use case changes, the list is updated: some functional blocks may be removed, others added, and some remain unchanged. Those functional blocks on the updated list remain critical for the use case currently running on the SoC. Performance sensors in those critical functional blocks remain active in the scan chain 350, while performance sensors in non-critical functional blocks may be bypassed—effectively removing them temporarily from the scan chain 350.

The use-case information communicated via connection 324 may originate from the CPU 104, such as from the hypervisor 112 within the CPU 104, or from other suitable hardware or software components that track the current use case in the portable computing device 100.

As an example, the use-case logic 326 may receive use-case information that lists the functional blocks 302, 306, and 310 as the ones deemed critical (or actively operating) for the current use case. Alternatively, the use-case information may be a code representing a specific use case, in which scenario the use -case logic 326 looks up a table stored in the memory inside the CPR controller 322 to retrieve the corresponding list of functional blocks. After obtaining the list, the use -case logic 326 configures the scan chain 350 to bypass the performance sensor 314 (or the group of performance sensors located in the functional block 304) and performance sensor 318 (or the group of performance sensors located in the functional block 308). The sensor topology (e.g., performance sensor 500) permits sensing data to bypass these sensors along the scan chain 350, thereby effectively removing them from the chain. This bypass is illustrated by dashed lines 602 and 604, while the arrows in the scan chain 350 represent the sequence in which the performance sensors take measurements block by block. In some alternative arrangements, dashed lines 602 and 604 can represent additional conductive traces with switches therein (not shown) that physically bypass the segments of the scan chain 350 located in functional blocks 304 and 308, respectively.

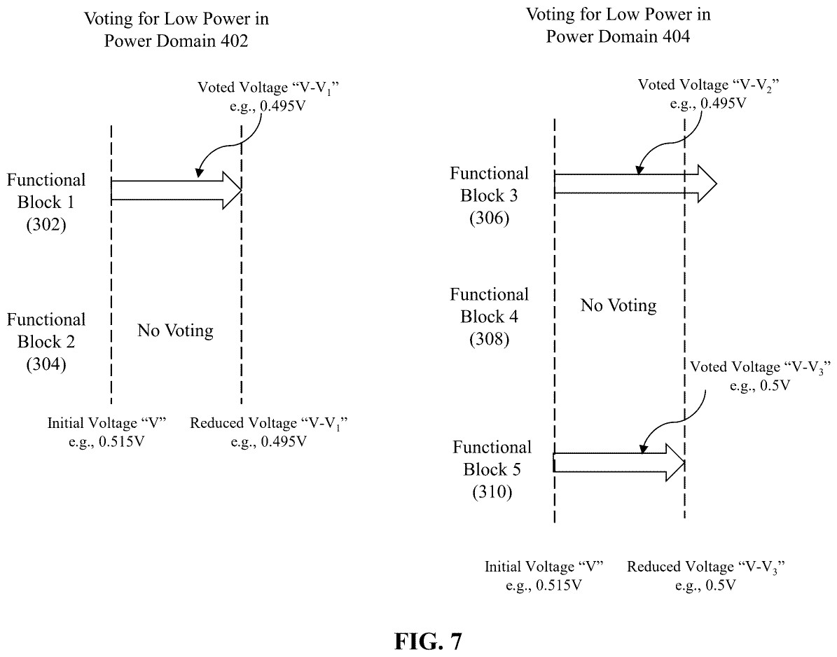

Referring to FIG. 7, bypassing the performance sensor 314 located in the functional block 304 excludes that block from a voting pool in the shared power domain 402. Likewise, bypassing the performance sensor 318 located in the functional block 308 excludes that block from a voting pool in the shared power domain 404. Consequently, votes to adjust supply voltage levels to the respective power domains are restricted to the processing resources critical to the current use case. In other words, votes from blocks deemed non-critical (or in a low-power or standby state) to the current use case are ignored because their needs are subordinate to the listed blocks in each shared power domain. In an alternative arrangement, functional blocks 304 and 308 may still cast votes, but the use-case logic 326 can ignore or filter them out.

Votes from the performance sensors in functional blocks designated as critical are thus treated as effective votes in each power domain's voting pool. By narrowing the vote to a subset of functional blocks in a power domain, dynamic power management can refine the minimum supply voltage more precisely. For example, as shown in FIG. 7, the initial supply voltage “V” for the shared power domain 402 is 0.515 V, and the functional block 302 votes to reduce it to “V−V₁,” which is 0.495 V. Although the functional block 304—if included—might vote for a higher voltage (e.g., 0.50 V), it is excluded because sensor 314 is bypassed. Consequently, the higher voltage that the functional block 304 might otherwise require does not dictate the minimum supply voltage the CPR controller 322 sets for P1. Instead, the CPR controller 322 can safely lower the supply to 0.495 V to meet the needs of the functional block 302 alone.

Similarly, in the shared power domain 404, the initial supply voltage “V” is 0.515 V. The functional block 306 votes for a reduced voltage “V−V₂” of 0.495 V, while the functional block 310 votes for “V−V₃” of 0.50 V. Although the functional block 308 might have requested a higher voltage (e.g., 0.505 V), it is excluded because the performance sensor 318 is bypassed. Hence, the higher voltage the functional block 308 might otherwise require does not dictate the minimum supply voltage for P 2. Instead, the CPR controller 322 selects 0.50 V to accommodate both the functional block 306 and the functional block 310. Reducing the supply voltage from 0.515 V to 0.50 V represents a power saving of about 6 percent in the shared domain 404.

In modern smartphones and other portable computing devices, certain use cases (usage patterns)—such as gaming, camera operation, video playback, or AI processing—place unique demands on performance of a multimedia (MM) platform in the device. The use-case-driven power optimization as discussed above is particularly useful to optimize performance of a multimedia platform.

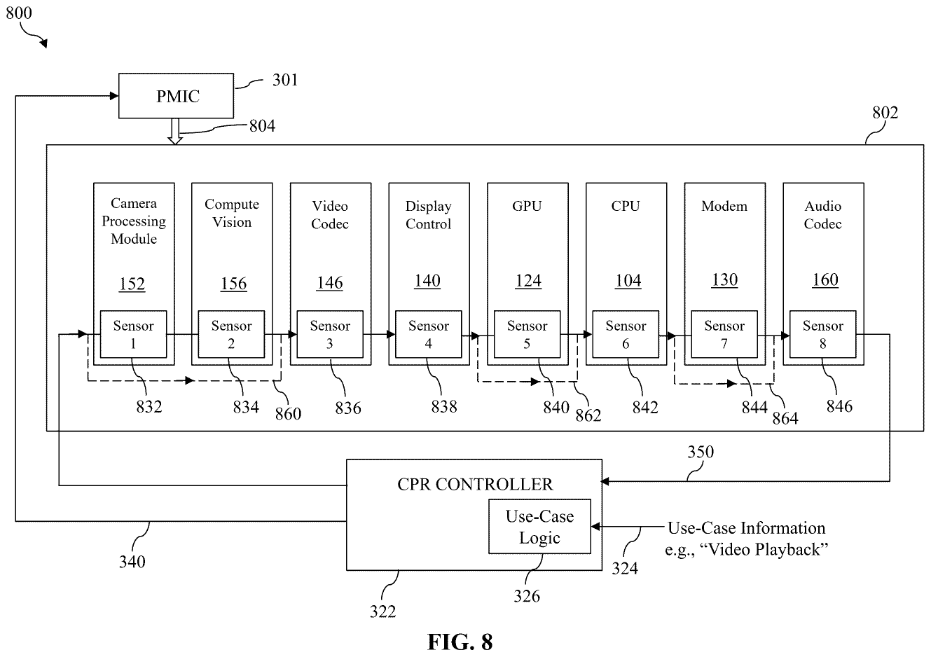

FIG. 8 is a schematic diagram of a system 800, such as an SoC, which includes a multimedia platform 802 powered by the PMIC 301 through a power bus 804. The multimedia platform 802 includes a plurality of functional blocks, such as camera processing module 152, compute vision 156, video codec 146, display control 140, GPU 124, CPU 104, Modem 130, and audio codec 160. The multimedia platform 802 may include more, fewer, or other functional blocks without departing from the scope of the present disclosure. The functional blocks may reside in separate cores or separate dies. Further, the functional blocks may reside in separate power domains, such as one or more functional blocks may have individual power domains and other functional blocks may reside in one or more shared power domains. The power bus 804 provides supply voltages to each of the individual and shared power domains (not separately shown). The CPR controller 322 provides a control signal to the PMIC 301 via connection 340. Measurements from performance sensors 832-846, which are distributed throughout the SoC, are collected and processed by the CPR controller 322 to determine the appropriate voltage levels for each of the individual and shared power domains.

The CPR controller 322 includes use-case logic 326, which configures the scan chain 350 and consequently the control signal in a manner that optimizes supply voltages to the power domains in the multimedia platform 802. By executing logic circuits and/or instructions in response to use-case information received via connection 324, the use-case logic 326 initiates or directs adjustments to the scan chain 350. These adjustments in turn influence the control signal that the CPR controller 322 sends to the PMIC 301.

As an example, the use-case logic 326 may receive use-case information indicating the multimedia platform 802 is in a “video playback” use case. Such use-case information may originate from the CPU 104, such as from the hypervisor 112 within the CPU 104, or from other suitable hardware or software components that track the current use case in the portable computing device 100. In a “video playback” use case, the critical path for multimedia signal processing includes, in sequence, the video codec 146, display control 140, CPU 104, and audio codec 160. The use-case logic 326 may retrieve the corresponding list of functional blocks—video codec 146, display control 140, CPU 104, and audio codec 160—by looking up a table stored in the memory of the CPR controller 322 using “video playback” as an index. Alternatively, the use-case information itself may include this list of critical functional blocks directly.

After obtaining the list, the use-case logic 326 configures the scan chain 350 to bypass the performance sensors in those functional blocks deemed not critical for the current use case, including performance sensor 832 (or the group of performance sensors located in the camera processing module 152), performance sensor 834 (or the group of performance sensors located in the compute vision 156), performance sensor 840 (or the group of performance sensors located in GPU 124), and performance sensor 844 (or the group of performance sensors located in Modem 130). The sensor topology (e.g., performance sensor 500) permits sensing data to bypass these sensors along the scan chain 350, thereby effectively removing them from the chain. This bypass is illustrated by dashed lines 860, 862, and 864, while the arrows in the scan chain 350 represent the sequence in which the performance sensors take measurements block by block. In some alternative arrangements, dashed lines 860, 862, and 864 can represent additional conductive traces with switches therein (not shown) that physically bypass the segments of the scan chain 350 located in camera processing module 152, compute vision 156, GPU 124, and modem 130.

Each individual or shared power domain maintains its own voting pool. When performance sensors in non-listed functional blocks are bypassed, those functional blocks are effectively removed from the relevant voting pool. Consequently, only critical processing resources related to the “video playback” use case, such as video codec 146, display control 140, CPU 104, and audio codec 160, contribute votes for adjusting the supply voltage in each power domain. By contrast, functional blocks deemed non-critical for the current use case, such as camera processing module 152, compute vision 156, GPU 124, and modem 130, are excluded from voting as their voltage needs are subordinate to the listed functional blocks. In an alternative arrangement, these non-critical functional blocks may still cast votes, but the use-case logic 326 ignores or filters them out.

Once the votes are collected, the CPR controller 322 sets the supply voltage for each power domain based on the votes from that domain. If only one functional block is listed for a domain, the supply voltage is simply set to the value requested by that functional block. Where two or more functional blocks are listed as critical in the same domain, the controller selects a voltage sufficient to meet the requirements of all listed functional blocks—typically the highest requested voltage. Alternatively, the CPR controller 322 may assign weights to the listed blocks; in such cases, it could adopt the voltage requested by the functional block with the highest weight, while simultaneously lowering the operating frequency of other functional blocks that voted for a higher voltage. This approach ensures all listed functional blocks in the domain can still function properly.

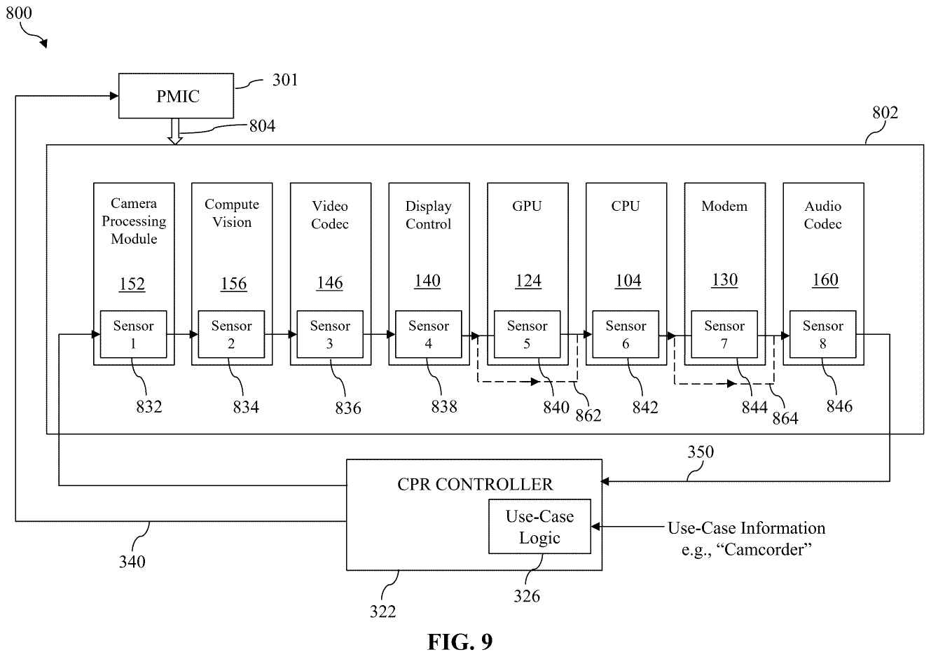

FIG. 9 illustrates the same system 800 shown in FIG. 8, but with the use-case logic 326 receiving updated use-case information indicating that the multimedia platform 802 has transitioned to a “camcorder” use case. In a “camcorder” use case, the critical path for multimedia signal processing involves, in sequence, the camera processing module 152, compute vision 156, video codec 146, display control 140, CPU 104, and audio codec 160. The use-case logic 326 may retrieve the corresponding list of functional blocks—camera processing module 152, compute vision 156, video codec 146, display control 140, CPU 104, and audio codec 160—by looking up a table stored in the memory of the CPR controller 322 using “camcorder” as an index. Alternatively, the use-case information itself may include this list of critical functional blocks directly.

After obtaining the updated list, the use-case logic 326 configures the scan chain 350 to bypass the performance sensors in those functional blocks deemed not critical for the current use case, including performance sensor 840 (or the group of performance sensors located in GPU 124) and performance sensor 844 (or the group of performance sensors located in Modem 130). Meanwhile, the previously bypassed performance sensor 832 (or the group of performance sensors located in the camera processing module 152) and performance sensor 834 (or the group of performance sensors located in the compute vision 156) are added back to the scan chain 350. The bypass illustrated by dashed lines 862 and 864 still remains, while the arrows in the scan chain 350 represent the sequence in which the performance sensors take measurements block by block. In some alternative arrangements, dashed lines 862 and 864 can represent additional conductive traces with switches therein (not shown) that physically bypass the segments of the scan chain 350 located in GPU 124 and modem 130.

Each individual or shared power domain maintains its own voting pool. When performance sensors in non-listed functional blocks are bypassed, those blocks are effectively removed from the relevant voting pool. Consequently, only critical processing resources related to the “camcorder” use case, such as camera processing module 152, compute vision 156, video codec 146, display control 140, CPU 104, and audio codec 160, contribute votes for adjusting the supply voltage in each power domain. By contrast, functional blocks deemed non-critical for the current use case, such as GPU 124, and modem 130, are excluded from voting as their voltage needs are subordinate to the listed functional blocks. In an alternative arrangement, these non-critical functional blocks may still cast votes, but the use-case logic 326 ignores or filters them out.

Once the votes are collected, the CPR controller 322 sets the supply voltage for each power domain based on the votes from that domain. If only one functional block is listed for a domain, the supply voltage is simply set to the value requested by that functional block. Where two or more functional blocks are listed as critical in the same domain, the controller selects a voltage sufficient to meet the requirements of all listed functional blocks—typically the highest requested voltage. Alternatively, the CPR controller 322 may assign weights to the listed blocks; in such cases, it could adopt the voltage requested by the functional block with the highest weight, while simultaneously lowering the operating frequency of other functional blocks that voted for a higher voltage. This approach ensures all listed functional blocks in the domain can still function properly.

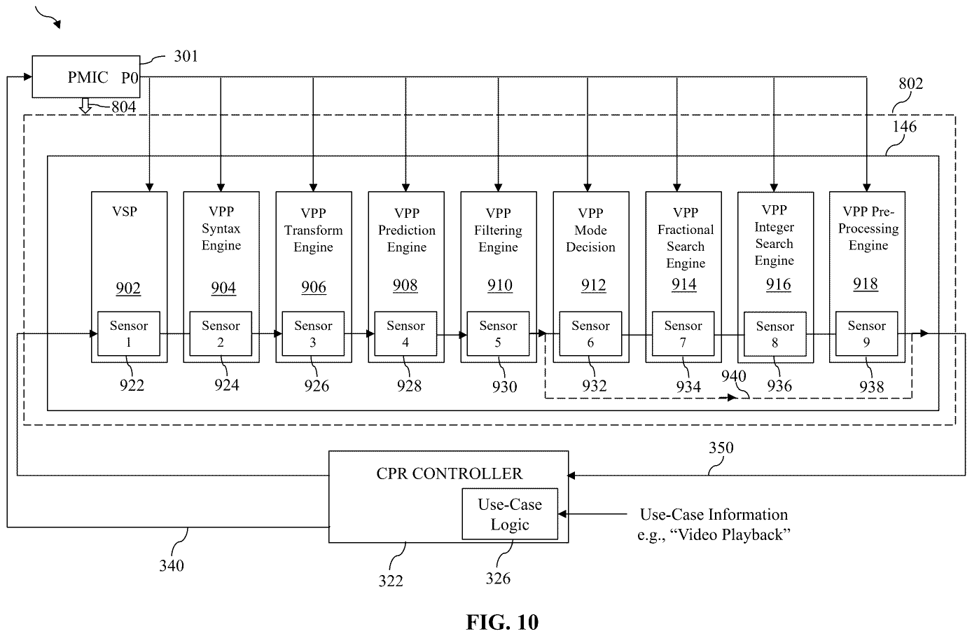

Reference is now made to FIG. 10. The use-case-driven power optimization discussed above can be applied not only at the SoC level but also at the module level, core level, and even within a functional block. For example, in the multimedia platform 802, the video codec 146 may include multiple functional blocks, not all of which are critical in a given use case. This enables further power optimization of the video codec 146 based on specific use cases. The use-case-driven power optimization described below, using the video codec 146 as an example, can similarly be applied to other modules in the system 800.

The video codec 146 includes a plurality of functional blocks, such as video streaming process (VSP) 902, video pixel process (VPP) syntex engine 904, VPP transform engine 906, VPP prediction engine 908, VPP filtering engine 910, VPP mode decision 912, VPP fractional search engine 914, VPP integer search engine 916, and VPP pre-processing engine 918. The video codec 146 may include more, fewer, or other functional blocks without departing from the scope of the present disclosure. In the illustrated arrangement, the functional blocks in the video codec 146 reside in the same shared power domain P0. The CPR controller 322 provides a control signal to the PMIC 301 via connection 340. Measurements from performance sensors 922-938, which are distributed throughout the video codec 146, are collected and processed by the CPR controller 322 to determine the appropriate voltage level for the shared power domain P0.

Under the exemplary use case “video playback”, the use-case logic 326 may retrieve not only video codec 146, display control 140, CPU 104, and audio codec 160 as the critical modules for the current use case as discussed above, but also the critical functional blocks in the video codec 146 for the current use case, such as VSP 902, VPP syntax engine 904, VPP transform engine 906, VPP prediction engine 908, and VPP filtering engine 910. The use-case logic 326 may retrieve the corresponding list of functional blocks by looking up a table stored in the memory of the CPR controller 322 using “video playback” as an index. Alternatively, the use-case information itself may include this list of critical functional blocks directly.

The performance sensors 922-938 residing inside the video codec 146 are part of the scan chain 350. After obtaining the list, the use-case logic 326 configures the scan chain 350 to bypass the performance sensors in those functional blocks deemed not critical for the current use case, including performance sensor 932 (or the group of performance sensors located in the VPP mode decision 912), performance sensor 934 (or the group of performance sensors located in the VPP fractional search engine 914), performance sensor 936 (or the group of performance sensors located in the VPP integer search engine 916), and performance sensor 938 (or the group of performance sensors located in VPP pre-processing engine 918). The sensor topology (e.g., performance sensor 500) permits sensing data to bypass these sensors along the scan chain 350, thereby effectively removing them from the chain. This bypass is illustrated by dashed line 940, while the arrows in the scan chain 350 represent the sequence in which the performance sensors take measurements block by block. In some alternative arrangements, dashed line 940 can represent additional conductive traces with switches therein (not shown) that physically bypass the segments of the scan chain 350 located in VPP mode decision 912, VPP fractional search engine 914, VPP integer search engine 916, and VPP pre-processing engine 918.

When performance sensors in non-listed functional blocks are bypassed, those functional blocks are effectively removed from the voting pool. Consequently, only critical processing resources related to the “video playback” use case, such as VSP 902, VPP syntax engine 904, VPP transform engine 906, VPP prediction engine 908, and VPP filtering engine 910 contribute votes for adjusting the supply voltage in each power domain. By contrast, functional blocks deemed non -critical for the current use case, such as VPP mode decision 912, VPP fractional search engine 914, VPP integer search engine 916, and VPP pre-processing engine 918, are excluded from voting as their voltage needs are subordinate to the listed functional blocks. In an alternative arrangement, these non-critical functional blocks may still cast votes, but the use-case logic 326 ignores or filters them out.

Once the votes are collected, the CPR controller 322 sets the supply voltage for the shared power domain P0 based on the votes. Since there are multiple votes, the CPR controller 322 selects a voltage sufficient to meet the requirements of all listed functional blocks—typically the highest requested voltage. Alternatively, the CPR controller 322 may assign weights to the listed blocks; in such cases, it could adopt the voltage requested by the functional block with the highest weight, while simultaneously lowering the operating frequency of other functional blocks that voted for a higher voltage. This approach ensures all listed functional blocks in the domain can still function properly. Further, if the video codec 146 shares the power domain P0 with other modules in the multimedia platform 802, rather than being the only module in that power domain, the CPR controller 322 treats the determined vote from the video codec 146 as one vote and submits it to the next round of voting. The next round of voting involves comparing the vote from the video codec 146 against those from other modules within the shared power domain to determine the final supply voltage.

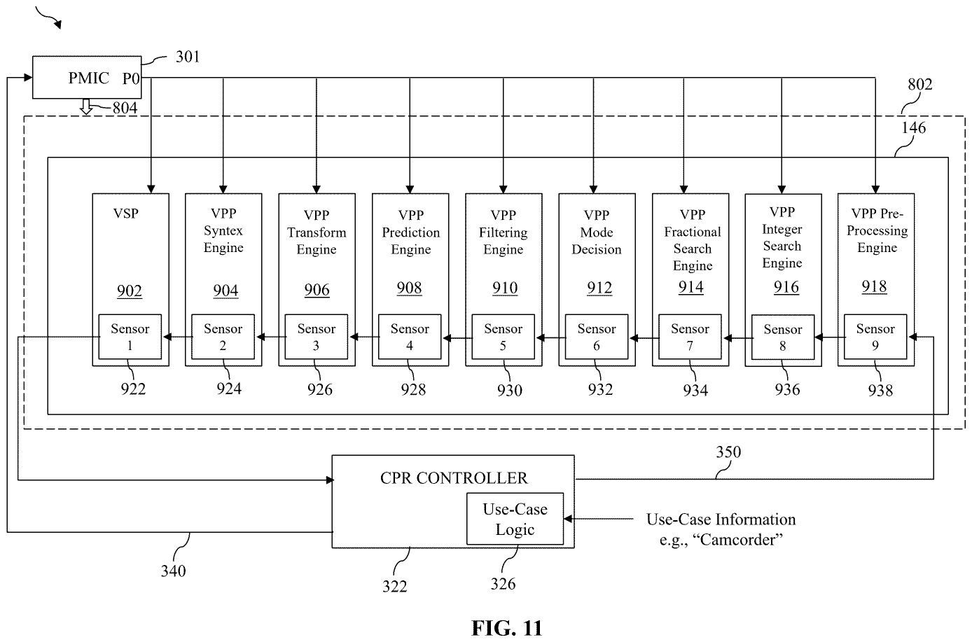

FIG. 11 illustrates the video codec 146 shown in FIG. 10, but with the use-case logic 326 receiving updated use-case information indicating that the multimedia platform 802 has transitioned to a “camcorder” use case. In a “camcorder” use case, the critical path for multimedia signal processing involves, in sequence, the VPP pre-processing engine 918, VPP integer search engine 916, VPP fractional search engine 914, VPP mode decision 912, VPP filtering engine 910, VPP prediction engine 908, VPP transform engine 906, VPP syntex engine 904, and VSP 902. Since all the functional blocks are listed as critical blocks for the “camcorder” use case, no performance sensors would be excluded from the scan chain 350. In other words, all the functional blocks would be included in the voting pool. Notably, the scan chain 350 may reverse its direction to allow the performance sensors take measurements block by block in the same direction as the signal flow during the multimedia signal processing under the “camcorder” use case.

Once the votes are collected, the CPR controller 322 sets the supply voltage for the shared power domain P0 based on the votes. Since there are multiple votes, the CPR controller 322 selects a voltage sufficient to meet the requirements of all listed functional blocks—typically the highest requested voltage. Alternatively, the CPR controller 322 may assign weights to the listed blocks; in such cases, it could adopt the voltage requested by the functional block with the highest weight, while simultaneously lowering the operating frequency of other functional blocks that voted for a higher voltage. This approach ensures all listed functional blocks in the domain can still function properly. Further, if the video codec 146 shares the power domain P0 with other modules in the multimedia platform 802, rather than being the only module in that power domain, the CPR controller 322 treats the determined vote from the video codec 146 as one vote and submits it to the next round of voting. The next round of voting involves comparing the vote from the video codec 146 against those from other modules within the shared power domain to determine the final supply voltage.

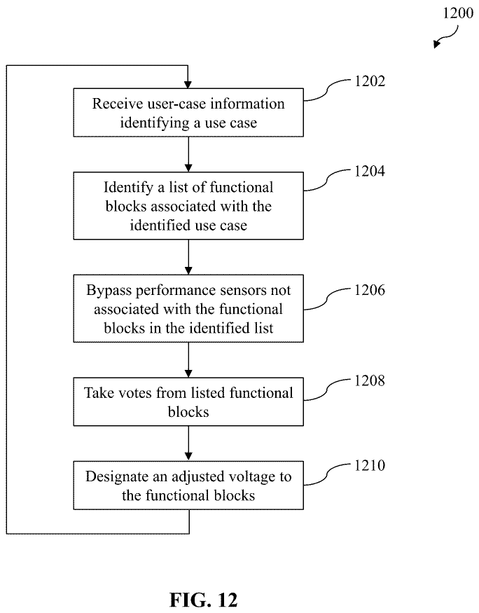

FIG. 12 is a flowchart illustrating an exemplary method 1200 for use-case-driven power optimization. Beginning at block 1202, the use-case logic in the CPR controller receives use-case information identifying a use case, such as “video playback” or “camcorder” use case. At block 1204, the use-case logic identifies a list of functional blocks deemed critical to the identified use case. At block 1206, the use-case logic configures the scan chain to bypass the performance sensors located in the non-listed functional blocks. At block 1208, the CPR controller take votes from the voting pool that includes the listed functional bocks and excludes the non-listed functional blocks. At block 1210, the CPR controller designate an adjusted voltage based on the votes. The voting may be at the SoC level. Alternatively, the voting may be at the module level, core level, and even within a functional block, after which the CPR controller will bring the voted volage as one vote to the higher level for the next round of voting, such as at the SoC level.

Modern smartphones and other portable computing devices experience varying performance demands depending on the usage scenario (“use case”). Activities such as gaming, camera operation, video playback, and AI processing each exert unique workloads on the system, requiring dynamic resource allocation to maintain optimal performance. By harnessing sensor feedback and performance data from each device's internal circuitry, it becomes possible to categorize (“bin”) the devices based on how well they meet the requirements of these specialized scenarios. In turn, each bin can be marketed to emphasize a particular strength. For example, chips that excel in high-frame-rate rendering might become “Gaming Phones,” those with optimized imaging capabilities might be branded as “Camera Phones,” and others might be specifically tuned for video streaming (“YouTube Phones”) or AI tasks (“AI Phones”). This tailored approach not only fine -tunes performance and power management for different workloads, but also creates clearer distinctions in the marketplace and boosts product value by allowing each device category to command a targeted price point.

Certain steps in the processes or process flows described in this specification naturally precede others for the invention to function as described. However, the invention is not limited to the order of the steps described if such order or sequence does not alter the functionality of the invention. That is, it is recognized that some steps may performed before, after, or in parallel (substantially simultaneously) with other steps without departing from the scope of the invention. In some instances, certain steps may be omitted or not performed without departing from the invention. Further, words such as “thereafter”, “then”, “next”, “subsequently”, etc. are not intended to limit the order of the steps. These words are simply used to guide the reader through the description of the exemplary method.

Additionally, one of ordinary skill in power management within a portable computing device is able to identify appropriate hardware and/or circuits and/or identify appropriate logic and determinations to implement the disclosed invention without difficulty based on the flow charts and associated description in this specification. Therefore, disclosure of a particular set of program code instructions, decision thresholds or detailed hardware devices is not considered necessary for an adequate understanding of how to make and use the invention. The inventive functionality and aspects of the claimed processor-enabled processes and circuit architectures are explained in more detail in the above description and in conjunction with the drawings, which may illustrate various process flows.

In one or more exemplary aspects as indicated above, the functions described may be implemented in hardware, software, firmware, or any combination thereof. If implemented in software, the functions may be stored as one or more instructions or code on a computer-readable medium, such as a non-transitory processor-readable medium. Computer-readable media include data storage media.

A storage media may be any available media that may be accessed by a computer or a processor. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Disk and disc, as used herein, includes compact disc (“CD”), laser disc, optical disc, digital versatile disc (“DVD”), floppy disk and blu-ray disc where disks usually reproduce data magnetically, while discs reproduce data optically with lasers. Combinations of the above should also be included within the scope of non-transitory computer-readable media.

Although selected aspects have been illustrated and described in detail, it will be understood that various substitutions and alterations may be made herein without departing from the present systems and methods, as defined by the following claims.

What is claimed is:

1. A method for dynamically controlling power consumption of a portable computing device, the portable computing device including a plurality of functional blocks, the method comprising:
receiving a use case;
identifying critical functional blocks from the plurality of functional blocks based on the use case;
taking votes from the identified critical functional blocks, wherein a vote indicates an adjustment to a supply voltage level; and
adjusting the supply voltage level based on the votes.

2. The method of claim 1, wherein the portable computing device is in a form of a mobile phone.

3. The method of claim 1, wherein the plurality of functional blocks are located in a multimedia platform.

4. The method of claim 1, wherein the plurality of functional blocks are located in a video codec.

5. The method of claim 1, wherein the portable computing device includes a plurality of performance sensors in a scan chain for measuring performance under process corners of the plurality of functional blocks.

6. The method of claim 5, further comprising:
bypassing a portion of the performance sensors not located in the critical functional blocks.

7. The method of claim 5, wherein the taking of the votes is by measuring the performance sensors located in the critical functional blocks.

8. The method of claim 5, wherein the scan chain is operable to reserve a signal direction based on the use case.

9. The method of claim 1, further comprising:
after the taking of the votes, categorizing the votes into different power domains,
wherein the adjusting of the supply voltage level is based on the votes in the respective power domain.

10. A system for dynamically controlling a power domain in a portable computing device, comprising:
a plurality of functional blocks sharing the power domain;
a plurality of performance sensors associated with the functional blocks; and
a controller drives the performance sensors,
wherein the controller is configured to:
receive information of a use case presently executed by the portable computing device;
identify from the functional blocks critical functional blocks associated with the use case;
take votes by measuring the performance sensors associated with the critical functional blocks; and
determine an adjusted supply voltage for the power domain.

11. The system of claim 10, wherein the controller is also configured to exclude the functional blocks not identified as the critical functional blocks from voting by disabling the performance sensors not associated with the critical functional blocks.

12. The system of claim 11, wherein the performance sensors each include a ring oscillator.

13. The system of claim 10, wherein the controller receives the information of the use case from a CPU.

14. The system of claim 10, wherein the adjusted supply voltage is determined by taking a vote representing a largest voltage level.

15. The system of claim 10, wherein the adjusted supply voltage is determined by taking a vote assigned with a largest weight.

16. The system of claim 10, wherein the controller is further configured to take a vote representing the adjusted supply voltage to a next round of voting.

17. An apparatus, comprising:
a plurality of means for sensing performance of circuitry in an integrated circuit, wherein at least one of the plurality of means for sensing performance is located in each of a plurality of functional blocks in the integrated circuit, and wherein the plurality of means for sensing performance include sensors for heterogeneous circuits that have different relationships between supply voltage and circuit speed; and
a means for controlling voltages of the plurality of functional blocks configured to:
collect a list of the plurality of functional blocks deemed critical for a use case;
assign the functional blocks in the list to a voting pool;
collect votes from the voting pool; and
determine a target voltage level for the plurality of functional blocks based on the collected votes.

18. The apparatus of claim 17, wherein the plurality of means for sensing performance are coupled to the means for controlling voltage in a scan chain.

19. The apparatus of claim 18, wherein a signal direction of the scan chain can be reversed based on the use case.

20. The apparatus of claim 17, wherein the means for controlling voltages is also configured to bypass a portion of the plurality of means for sensing performance based on the use case.
